(19) United States
(12) Patent Application Publication
(10) Pub. No.: US 2021/0006021 A1
(43) Pub. Date: Jan. 7, 2021

(54) CONDUCTIVE BUILDING BLOCK HAVING DIFFERENT HEIGHTS

(71) Applicant: LONGMEN GETMORE POLYURETHANE CO., LTD., HUIZHOU CITY (CN)

(72) Inventor: Chia-Yen Lin, HUIZHOU CITY (CN)

(21) Appl. No.: 16/673,979

(22) Filed: Nov. 5, 2019

(30) Foreign Application Priority Data
Jul. 1, 2019 (CN) 201910593319.2

(51) Int. Cl. H01R 33/92; H01R 13/66; H01R 13/717; H01R 13/424

(52) U.S. Cl. CPC H01R 33/92; H01R 13/665; F21V 23/06; H01R 13/7175; H01R 13/424; H01R 13/6675

(57) ABSTRACT

A conductive building block having electric circuit disposed therein includes a top cover and at least one electric connection member. The top cover has a top-cover top portion, a first region, a second region, at least one communication groove, and at least one conductive stud. The first and second regions are projected downward from the top-cover top portion, and a height of the first region is different from a height of the second region. The electric connection member passes through the communication groove to be disposed in the first and second regions, and passes through the conductive stud. Thus, electronic elements, such as a battery and light emitting elements, which can provide functions, can be installed in the first region having a larger space. The electric circuit in the first region can extends to the second region by the electric connection member.

### CROSS-REFERENCE TO RELATED APPLICATION

This application claims the priority of Chinese patent application No. 201910593319.2, filed on Jul. 1, 2019, which is incorporated herewith by reference.

### BACKGROUND OF THE INVENTION

### 1. Field of the Invention

The present invention relates generally to a conductive building block having an electric circuit disposed in an inner space thereof, wherein the electric circuits are electrically connected when two conductive building blocks are engaged with each other, and more particularly to a conductive building block having different heights.

### 2. The Prior Arts

Conventional conductive building blocks are engaged with each other by studs and recesses. An electric circuit is disposed in the conductive building block and has metal joints at engaging portions of the conductive building block. Thus, after the two conductive building blocks are connected with each other, the electric circuits therein can be electrically connected with each other, such that the current can be conducted across the conductive building blocks.

The conventional conductive building blocks can be classified as electric connection type conductive building blocks and functional type conductive building blocks. There are only metal conductive pieces in the electric connection type building block. The electric circuit can extend by the connection of the conductive building blocks. On the other hand, the functional type conductive building block is further provided with a variety of functional elements, such as a circuit board, a battery, and LEDs disposed at the inside to provide various additional functions such as power supply and illumination. Because the inner space of the functional type conductive building block accommodates more elements, a height of the functional type conductive building block is usually higher than that of the electric connection type conductive building block.

The conventional conductive building blocks can only be connected with each other through the engagement of the studs on the top surface with the recesses on the bottom surfaces thereof. As such, if the electric circuit is intended to be extended from a functional type conductive building block to a lateral side of the functional type conductive building block, it needs to first connects an electric connection type conductive building block to the top surface or the bottom surface of the functional type conductive building block, and then the electric circuit can be extended to the lateral side through the connected electric connection type conductive building block. However, such approach increases the height of the connected conductive building blocks and needs more conductive building blocks in the meantime. Therefore, the complexity and the cost of the connection of the conductive building blocks increase.

Therefore, it needs to improve the conventional conductive building block.

### SUMMARY OF THE INVENTION

In view of the advantages and disadvantages of the conventional designs, the present invention provides a conductive building block having different heights, so as to reduce the volume and the cost of the conductive building blocks.

In order to achieve the foregoing objective, the technical means adopted by the present invention is a conductive building block having different heights, comprising: a top cover, including: a top-cover top portion; a first region projected downward from the top-cover top portion and including a first-region side portion, the first-region side portion projected from a bottom surface of the top-cover top portion, and the first-region side portion and the top-cover top portion surrounding to form a first inner space and a first bottom opening; at least one second region projected downward from the top-cover top portion and connected with a side of the first region, the at least one second region including a second-region side portion, the second-region side portion projected from the bottom surface of the top-cover top portion and connected with the first-region side portion, the second-region side portion and the top-cover top portion surrounding to form a second inner space and a second bottom opening, a distance that the second-region side portion is projected from the top-cover top portion being different from a distance that the first-region side portion is projected from the top-cover top portion; at least one communication groove passing through the first-region side portion and the second-region side portion, extending to an opening circumference of the first bottom opening and an opening circumference of the second bottom opening, and communicating the first inner space with the second inner space; and at least one conductive stud projected from and formed on a top surface of the top-cover top portion; and at least one electric connection member received in the first inner space and the second inner space and passing through the at least one communication groove, the at least one electric connection member received in and passing through the at least one conductive stud.

The advantages of the present invention include that the top cover disposed with the adjacent first region and second region having different heights (a distance the second-region side portion projects from the top-cover top portion is different from a distance the first-region side portion projects from the top-cover top portion). As such, one of the regions have taller height and larger inner space, in which various elements which can add functions of the conductive building block such as battery and LEDS can be installed. In the meantime, the electric circuit of the first region transversely extends the second region through the electric connection member, and can selectively further extends to the conductive stud of the second region. By that means, when the various functions such as power supply and lighting are needed in the combination of the conductive building blocks, the function related electric circuit can be transversely extended through the present invention, such that the overall height of the combination of the conductive building blocks can be reduced, the numbers of the conductive building blocks for combination can be decreased in the meantime, and the complexity and the cost of the combination of the conductive buildings can be lowered. As the combination of the conductive building blocks is a vehicle model, one conductive building block of the present invention can be provided as a chassis of the vehicle model and accommodates the battery supplying the power to the lights, so as to simplify the complexity of the vehicle model.

According to an embodiment, the conductive building block having different heights as mentioned above further comprises a circuit board disposed in the first inner space and electrically connected with the at least one electric connection member, the at least one electric connection member includes at least one connection portion and a projection portion, an end of the projection portion is connected with the circuit board, another end of the projection portion is connected with the at least one connection portion, the at least one connection portion and the projection portion are both made of a conductive material.

According to an embodiment, in the conductive building block having different heights as mentioned above, at least one projection portion abutting socket is defined in the bottom surface of the top-cover top portion; and the projection portion of the at least one electric connection member includes at least one top-cover projection portion, the top-cover projection portion extends toward the top-cover top portion and is inserted into the projection portion abutting socket, two sides of the top-cover projection portion are respectively pressed against the two side walls of the projection portion abutting socket.

According to an embodiment of the present invention, in the conductive building block having different heights as mentioned above, a projection portion barb is projected from a side of the top-cover projection portion, a pointed end of the projection portion barb is pressed against the side wall of the projection portion abutting socket to restrict the projection portion moving in a direction away from the top-cover top portion.

According to an embodiment of the present invention, in the conductive building block having different heights as mentioned above, the projection portion is pressed against the at least one connection portion toward the top-cover top portion.

According to an embodiment of the present invention, in the conductive building block having different heights as mentioned above, at least one connection portion abutting socket is defined in the bottom of the top-cover top portion; and the electric connection member passes through and is fixed in the connection portion abutting socket, the projection portion of the electric connection member includes at least one connection portion holder, the connection portion holder holds the connection portion, the connection portion holder extends toward the top-cover top portion to be inserted into the connection portion abutting socket, two sides of the connection portion holder are presses against the two side walls of the connection portion abutting socket, respectively.

According to an embodiment of the present invention, the conductive building block having different heights as mentioned above further comprises a bottom seat disposed in the first inner space and located at the first bottom opening, at least one first-region engaging recess is defined in and passes through the bottom seat, a shape of the at least one first-region engaging recess corresponds to a shape of the at least one conductive stud.

According to an embodiment of the present invention, in the conductive building block having different heights as mentioned above, at least one second-region engaging recess is defined in the second inner space at the second bottom opening, a shape of the at least one second-region engaging recess corresponds to a shape of the at least one conductive stud.

According to an embodiment of the present invention, in the conductive building block having different heights as mentioned above, a plurality of embedding ribs are projected from an inner wall of the second inner space, the plurality of embedding ribs extend to the second bottom opening and surround to form the at least one second engaging recess.

### BRIEF DESCRIPTION OF THE DRAWINGS

The present invention will be apparent to those skilled in the art by reading the following detailed description of a preferred embodiments thereof, with reference to the attached drawings, in which:

FIG. 1 is a perspective view showing a conductive building block according to the present invention;

FIG. 2 is a bottom view showing the conductive building block according to the present invention;

FIG. 3 is a schematic view showing assembling a battery to the conductive building block according to the present invention;

FIG. 4 is an exploded view showing elements of the conductive building block according to the present invention;

FIG. 5 is a side view showing an electric connection member according to the present invention;

FIG. 6 is a side view showing an electric connection member according to another embodiment of the present invention;

FIG. 7 is a cross sectional view showing a position of a projection portion of an electric connection member according to the present invention;

FIG. 8 is a cross sectional view showing a first region according to the present invention;

FIG. 9 is a cross sectional view showing connection portions received in and passing through connection portion abutting sockets according to the present invention;

FIG. 10 is a cross sectional view showing a position of an electric connection member according to still another embodiment of the present invention; and

FIG. 11 is a cross sectional view showing a position of the battery according to the present invention.

### DETAILED DESCRIPTION OF THE PREFERRED EMBODIMENT

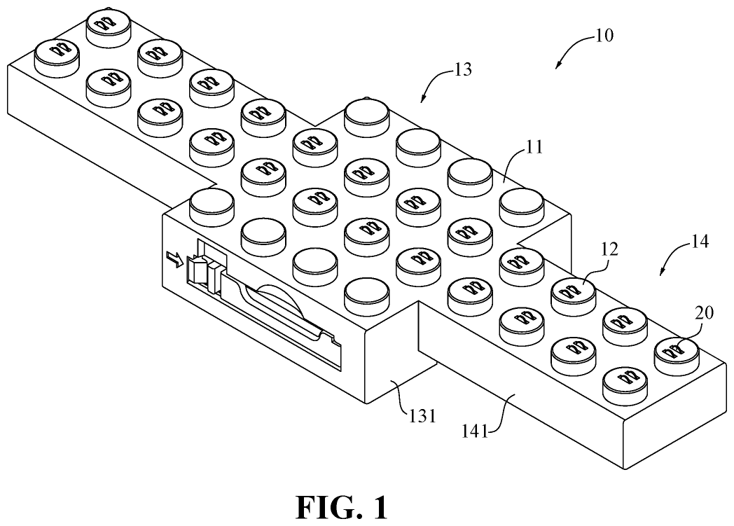

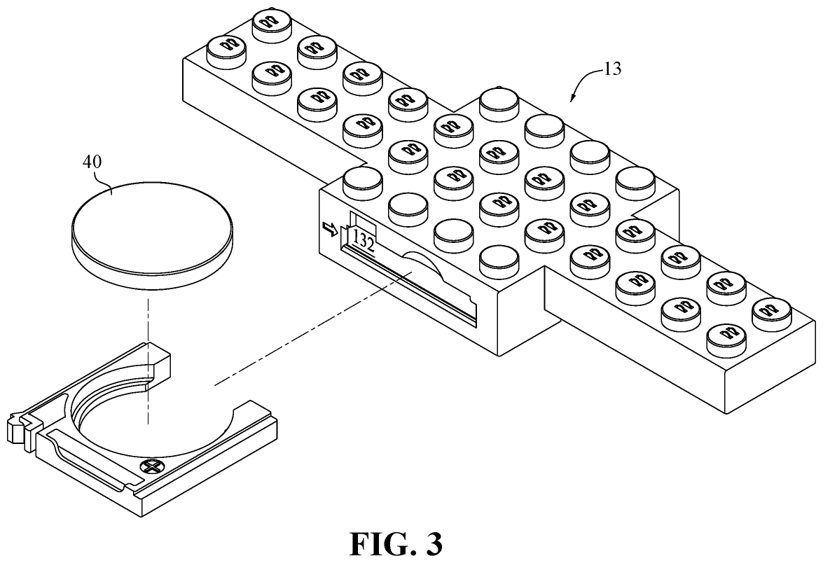

Referring to FIGS. 1 to 4, a conductive building block having different heights according to the present invention includes a top cover 10 and two electric connection members 20. According to an embodiment, the conductive building block having different heights may further include a circuit board 30 and a bottom seat 50. Moreover, a battery 40 may be further provided when the conductive building block of the present invention is in use.

The top cover 10 is integrally formed according to the embodiment of the present invention and specifically a single element produced by the plastic injection molding. However, the top cover 10 may be made of a material other than the plastic. The top cover 10 includes a top-cover top portion 11, a plurality of conductive studs 12, a first region 13, two second regions 14, a plurality of second-region engaging recesses 15, and two communication grooves 16.

The first region 13 and the two second region 14 are projected downward from the top-cover top portion 11. The two second regions 14 are respectively connected with the two opposite sides of the first region 13, but the positions of the two second regions 14 are not limited thereto. Furthermore, instead of two second regions 14, the top cover 10 may include only one second region 14.

The conductive studs 12 are projected to be formed on a top surface of the top-cover top portion 11. According to the embodiment of the present invention, the conductive studs 12 are disposed on the first region 13 and the two second regions 14 and arranged along a direction connecting the two second regions 14, but the positions of the conductive studs 12 are not limited thereto. The two electric connection members 20 are received in the first region 13 and the two second regions 14, and pass through the conductive studs 12. According to the embodiment of the present invention, a positive hole and a negative hole pass through an outer end of each conductive stud 12. The two electric connection members 20 include a positive electric connection member and a negative electric connection member. The two electric connection members 20 are disposed in and pass through the corresponding positive holes and negative holes, respectively. By this configuration, when engaged with any one of the conductive studs 12 of the present invention, a conventional conductive building block can be electrically connected with the two electric connection members 20 of the present invention, so as to achieve the effect of the electric circuit extension, but the configuration thereof are not limited thereto. According to another preferred embodiment of the present invention, a number of the conductive connection studs 12 may be two, the same as the number of the electric connection members 20. In that case, the two conductive studs 12 include one positive conductive stud and one negative conductive stud. The positive conductive stud is provided with only one positive hole passing therethrough, and the negative conductive stud is provided with only one negative hole passing therethrough. The two electric connection members 20 are received in and pass through the positive hole and the negative hole of the two conductive studs 12, respectively. The terms “positive” and “negative” are adopted to correspond to a DC circuit according to the embodiments of the present invention, but are not intended to restrict the functions of the two electric connection members 20.

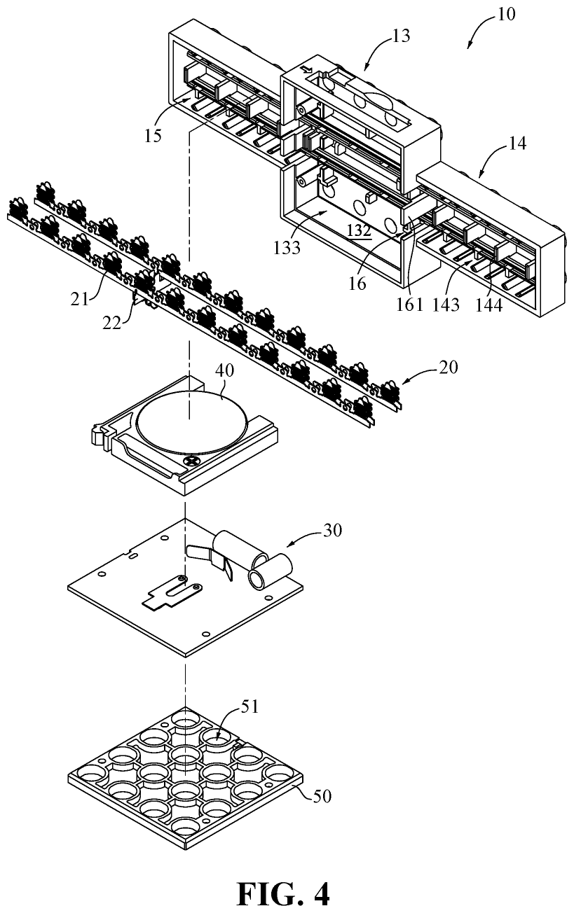

Referring to FIGS. 4 and 11, the first region 13 has a first-region side portion 131 projected from a bottom surface of the top-cover top portion 11. The first-region side portion 131 and the top-cover top portion 11 surround to form a first inner space 132 and a first bottom opening 133. The two second regions 14 are projected downward from the top-cover top portion 11. The two second regions 14 are connected with the two opposite sides of the first region 13, respectively. Each of the second regions 14 has a second-region side portion 141 projected from the bottom surface of the top-cover top portion 11. The second-region side portions 141 are connected with the first-region side portion 131. The second-portion side portion 141 and the top-cover portion 11 surround to form a second inner space 142 and a second bottom opening 143. However, the positions of the two second region 14 are not limited to the two opposite sides of the first region 13 and a number of the second region may be only one. A distance that the second-region side portion 141 is projected from the top-cover top portion 11 is smaller than a distance that the first-region side portion 131 is projected from the top-cover top portion 11. That is, a height of the first region 13 is higher than a height of the second regions 14, such that the conductive building block of the present invention has different heights. According to the embodiment of the present invention, the first-region side portion 131 and the second-region side portion 141 both include rectangular circumferential walls, but are not limited thereto. The first-region side portion 131 and the second-region side portion 141 may have other shape other than the rectangle. Furthermore, the top cover 10 is not limited to be integrally formed and may be formed by multiple elements as long as the height of the first region 13 is different from that of the second region 14, such that the conductive building block has different heights.

According to the embodiment of the present invention, a plurality of second-region engaging recesses 15 are defined in the second inner space 142 at the second bottom opening 143. Specifically, a plurality of embedding ribs 144 are projected from an inner wall of the second inner space 142 and extend to the second bottom opening 143. The embedding ribs 144 surround to form two rows of the second-region engaging recesses 15 at the second bottom opening 143. A shape of the second-region engaging recess 15 corresponds to that of the conductive stud 12. That is, when two of the conductive building blocks according to the present invention are connected with each other, the conductive studs 12 of one of the conductive building blocks may be engaged with the second-region engaging recesses 15 of another conductive building block, but are not limited thereto. According to the present invention, the second region 14 may be provided with only one second-region engaging recess 15 or even no second-region engaging recess 15 at all.

Two communication grooves 16 pass through the first-region side portion 131 and the second-region side portion 141, extend to an opening circumference of the first bottom opening 133 and an opening circumference of the second bottom opening 143, and communicate the first inner space 132 with the second inner space 142. According to the embodiment of the present invention, the two communication grooves 16 pass through connection walls of the two second regions 14 and the first region 13, but not limited thereto. According to another embodiment of the present invention in which there is only one second region 14, a number of the communication groove 16 is one which corresponds to the number of the second region 14. According to the embodiment of the present invention, a communication-groove shielding plate 161 is projected downward from the bottom surface of the top-cover top portion 11 and is located in the communication groove 16. A distance that the communication-groove shielding plate 161 is projected from the top-cover top portion 11 is substantially the same as the distance that the fist-region side portion 131 is projected from the top-cover top portion 11, so as to reduce a cross sectional area of the communication groove 16 to reduce a risk of foreign matter, such as dust, entering the first inner space 132.

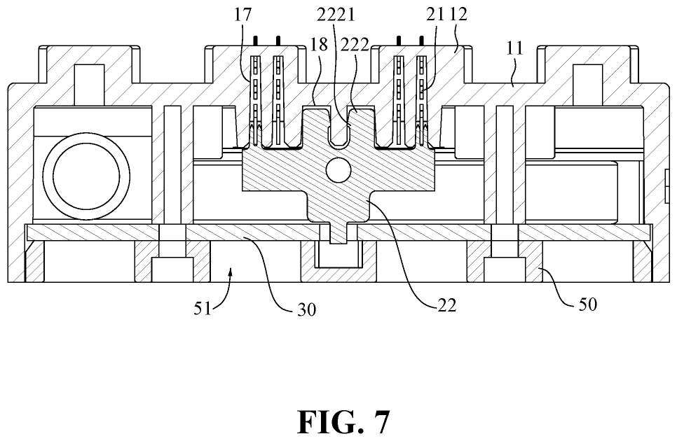

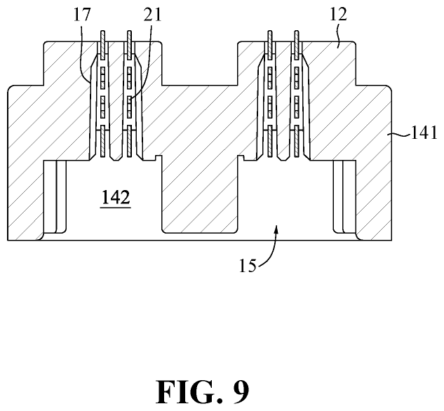

Referring to FIGS. 4, 7, and 9, according to the embodiment, a plurality of connection portion abutting sockets 17 are defined in the bottom of the top-cover top portion 11. The connection portion abutting socket 17 has a width gradually decreasing in a direction from bottom to top of the top-cover top portion 11. At least one projection portion abutting socket 18 are defined in the bottom of the top-cover top portion 11, and the projection portion abutting socket 18 has a width gradually decreasing in a direction from bottom to top of the top-cover top portion 11.

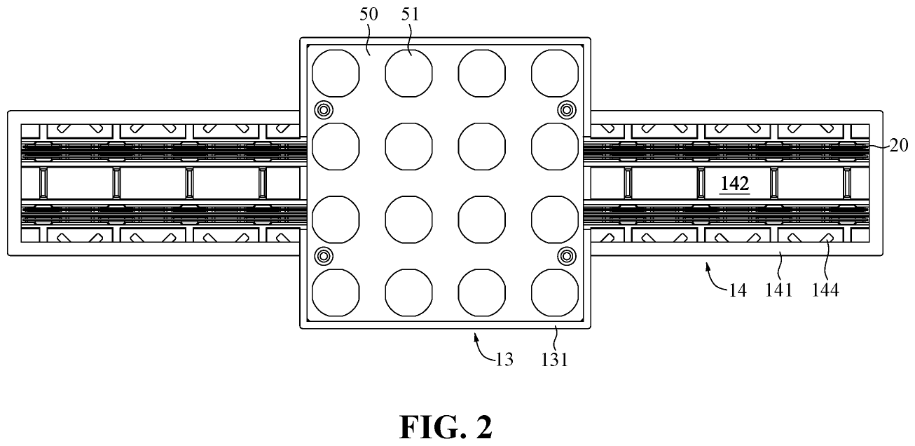

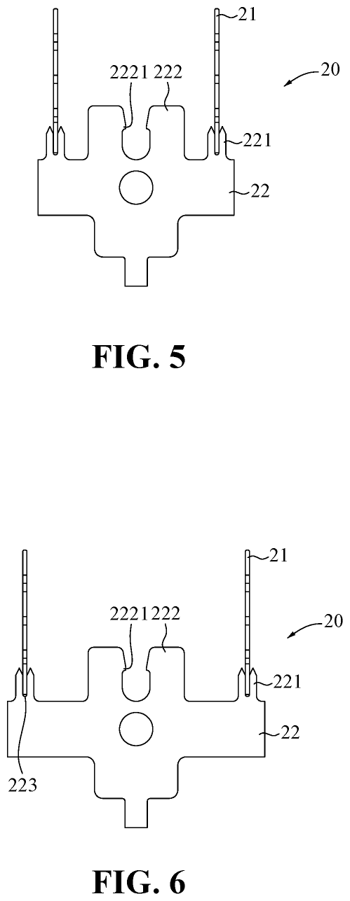

Referring to FIGS. 2, 4 to 7, and 11, the electric connection members 20 are disposed in the first inner space 132 and the second inner space 142 and pass through the communication grooves 16. The electric connection members 20 are received in and pass through the conductive studs 12. The specific configurations of the electric connection members 20 and the conductive studs 12 are described as the foregoing description and therefore are not repeated here. According to the embodiment, each electric connection member 20 includes two sheet-shaped connection portions 21 and one sheet-shaped projection portion 22. The connection portion 21 extends upward and passes through the connection portion abutting socket 17 and the conductive stud 12 so as to be projected out of the conductive stud 12. Thus, it facilitates the conductive building block of the present invention to be engaged with and simultaneously electrically connected with the conventional conductive building block. According to the embodiment, the projection portion 22 includes two connection portion holders 221 and two top-cover projection portions 222. The two connection portion holders 221 hold the two connection portion 21, respectively. The connection portion holder 221 extends toward the top-cover top portion 11 to be inserted into the connection portion abutting socket 17. Two sides of the connection portion holder 221 are pressed against the two side walls of the connection portion abutting socket 17, respectively. Because the width between the two side walls of the connection portion abutting socket 17 gradually decreases in a direction from bottom to top of the top-cover top portion 11, the connection portion holder 221 is pressed against the connection portion abutting socket 17. Therefore, the connection portion 221 can firmly holds the connection portions 21, thereby keeping the function of the electric connection normal. There may be only one connection portion 21 and one connection portion holder 221 which correspond to the arrangement of the conductive studs 12.

According to the embodiment of the present invention, the top-cover projection portion 222 extends toward the top-cover top portion 11 and is inserted into the projection portion abutting socket 18. A projection portion barb 2221 is projected from a side of the top-cover projection portion 222. The width between the two side walls of the projection portion abutting socket 18 gradually decreases in a direction from bottom to top of the top-cover top portion 11, two sides of the top-cover projection portion 222 are pressed against the two side walls of the projection portion abutting socket 18, so that the projection portion abutting socket 18 can press and hold the top-cover projection portion 222. In the meantime, a pointed end of the projection portion barb 2221 is pressed against the side wall of the projection portion abutting socket 18 to prevent the projection portion 22 moving in a direction away from the top-cover top portion 11, so as to ensure that the projection portion 22 is securely engaged with the top-cover top portion 11. Moreover, an inner wall surface of an abutting groove 223 formed in the connection portion holder 221 faces toward the top-cover top portion 11 and abuts the connection portion 21, such that the connection portion 21 can be pushed upwardly by the projection portion 22 and kept passing through the connection portion abutting socket 17, thereby making sure the electric connection between the connection portion 21 and the projection portion 22, strengthening the force that the connection portion holder 221 holds the connection portion 21, and ensuring the electric connection member 20 can correctly pass through and be disposed in the conductive stud 12.

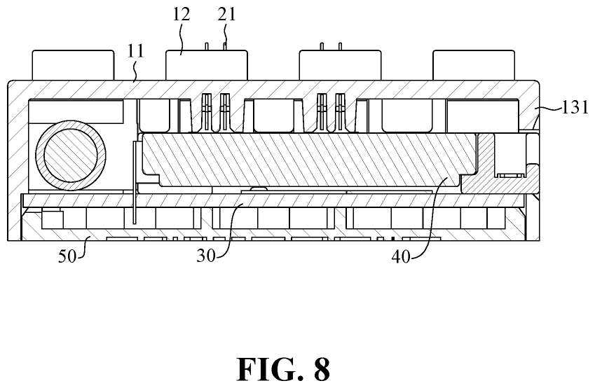

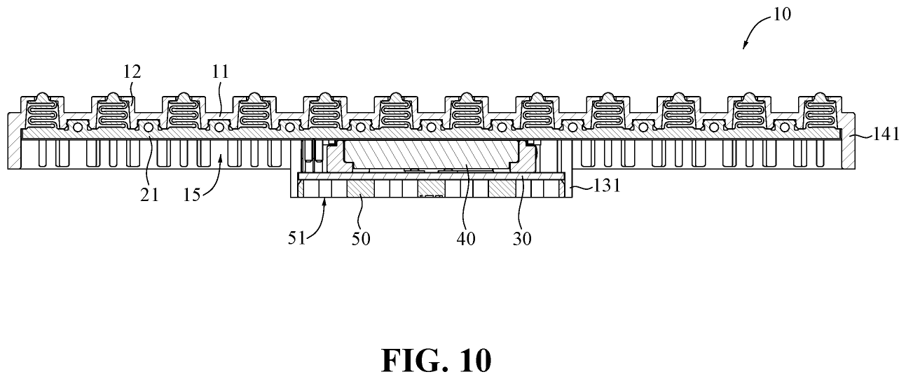

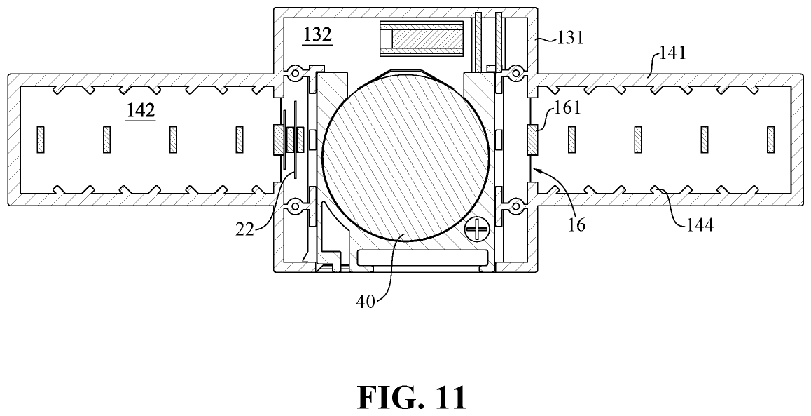

Referring to FIGS. 4, 8, 10, and 11, the circuit board 30 and the battery 40 are disposed in the first inner space 132, and the circuit board 30 is electrically connected with the two electric connection members 20. Specifically, the circuit board 30 is electrically connected with the projection portion 22 of the electric connection members 20. Two poles of the battery 40 are respectively electrically connected with the circuit board 30 and are respectively electrically connected with the two electric connection members 20 via the circuit board 30.

Referring to FIGS. 2, 4, and 10, according to the embodiment of the present invention, the bottom seat 50 is located at the first bottom opening 133. The bottom seat 50 is provided with a plurality of first-region engaging recesses 51 passing therethrough. A shape of the first-region engaging recess 51 corresponds to that of the conductive stud 12. That is, when two of the conductive building blocks according to the present invention are connected with each other, the conductive studs 12 of one of the conductive building blocks may be engaged with the first-region engaging recesses 51 of another conductive building block, but are not limited thereto. According to another embodiment, the present invention may include no bottom seat 50. When there is no bottom seat 50 in the present invention, the first-region engaging recesses 51 may be formed by inner walls of the first inner space 132. According to still another embodiment, the present invention may even include no first-region engaging recess 51 at all.

Referring to FIG. 1, the conductive building blocks of the present invention can be adopted to make a vehicle model. One conductive building block of the present invention may be used as a vehicle chassis. The conductive studs 12 disposed on one end of the top cover 10 are engaged with a conventional illuminating conductive building block for headlights and the conductive studs 12 disposed on another end of the top cover 10 are engaged with a conventional illuminating conductive building block for taillights. Conventional building blocks for tires are connected with the bottom surfaces of the two second regions 14. Another conventional building block is connected to the top cover 10 to from the vehicle body. The conventional illuminating conductive building blocks for the headlights and taillights are powered by the battery 40 through the electric connection members 20 to emit light.

In summary, according to the present invention, the top cover 10 of the conductive building block includes the first region 13 having a larger height and inner space and the second regions 14 having a smaller height. The first region 13 and the second regions 14 are laterally arranged and are adjacent to each other. The electric connection members 20 are received in and pass through the first region 13 and the second regions 14, so that the electric circuit of the first region 13 can extend to the second regions 14 through the electric connection members 20. The electric connection member 20 may optionally be received in and pass through the conductive stud 12 located in the second regions 14. Therefore, the volume and the cost of the conductive building blocks of the present invention can be reduced.

Furthermore, according to another preferred embodiment of the present invention, the battery is not provided in the first region 13, micro-sized electric elements are mounted on the circuit board 30 instead. As a result, the first inner space 132 of the first region 13 can be further reduced. Therefore, the distance that the second-region side portion 141 is projected from the top-cover top portion 11 is larger than the distance that the first-region side portion 131 is projected from the top-cover portion 11. That is, the height of the first region 13 is smaller than that of the second region 14.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A conductive building block having different heights, comprising:
a top cover, including:
a top-cover top portion;
a first region projected downward from the top-cover top portion and including a first-region side portion, the first-region side portion projected from a bottom surface of the top-cover top portion, and the first-region side portion and the top-cover top portion surrounding to form a first inner space and a first bottom opening;
at least one second region projected downward from the top-cover top portion and connected with a side of the first region, the at least one second region including a second-region side portion, the second-region side portion projected from the bottom surface of the top-cover top portion and connected with the first-region side portion, the second-region side portion and the top-cover top portion surrounding to form a second inner space and a second bottom opening, a distance that the second-region side portion is projected from the top-cover top portion being different from a distance that the first-region side portion is projected from the top-cover top portion;
at least one communication groove passing through the first-region side portion and the second-region side portion and communicating the first inner space with the second inner space; and
at least one conductive stud projected from and formed on a top surface of the top-cover top portion; and
at least one electric connection member received in the first inner space and the second inner space and passing through the at least one communication groove, the at least one electric connection member received in and passing through the at least one conductive stud.

2. The conductive building block having different heights according to claim 1, further comprising a circuit board disposed in the first inner space and electrically connected with the at least one electric connection member, wherein the at least one electric connection member includes at least one connection portion and a projection portion, an end of the projection portion is connected with the circuit board, another end of the projection portion is connected with the at least one connection portion, the at least one connection portion and the projection portion are both made of a conductive material.

3. The conductive building block having different heights according to claim 2, wherein:
at least one projection portion abutting socket is defined in the bottom surface of the top-cover top portion; and
the projection portion of the at least one electric connection member includes at least one top-cover projection portion, the top-cover projection portion extends toward the top-cover top portion and is inserted into the projection portion abutting socket, two sides of the top-cover projection portion are respectively pressed against the two side walls of the projection portion abutting socket.

4. The conductive building block having different heights according to claim 3, wherein a projection portion barb is projected from a side of the top-cover projection portion, a pointed end of the projection portion barb is pressed against the side wall of the projection portion abutting socket to restrict the projection portion moving in a direction away from the top-cover top portion.

5. The conductive building block having different heights according to claim 3, wherein the projection portion is pressed against the at least one connection portion toward the top-cover top portion.

6. The conductive building block having different heights according to claim 2, wherein:
at least one connection portion abutting socket is defined in the bottom of the top-cover top portion; and
the electric connection member passes through and is fixed in the connection portion abutting socket, the projection portion of the electric connection member includes at least one connection portion holder, the connection portion holder holds the connection portion, the connection portion holder extends toward the top-cover top portion to be inserted into the connection portion abutting socket, two sides of the connection portion holder are presses against the two side walls of the connection portion abutting socket, respectively.

7. The conductive building block having different heights according to claim 1, further comprising a bottom seat disposed in the first inner space and located at the first bottom opening,
wherein at least one first-region engaging recess is defined in and passes through the bottom seat, a shape of the at least one first-region engaging recess corresponds to a shape of the at least one conductive stud.

8. The conductive building block having different heights according to claim 1, wherein at least one second-region engaging recess is defined in the second inner space at the second bottom opening, a shape of the at least one second-region engaging recess corresponds to a shape of the at least one conductive stud.

9. The conductive building block having different heights according to claim 8, wherein a plurality of embedding ribs are projected from an inner wall of the second inner space, the plurality of embedding ribs extend to the second bottom opening and surround to form the at least one second engaging recess.
